(19) United States
(12) Patent Application Publication
(10) Pub. No.: US 2024/0391121 A1
(43) Pub. Date: Nov. 28, 2024

(54) A DEVICE FOR CLAMPING LOGS DURING CUTTING, LOG SAW COMPRISING THE DEVICE AND METHOD

(71) Applicant: Valmet Tissue Converting S.p.A., Lucca (IT)

(72) Inventors: Matteo GALOPPINI, Lucca (IT); Mario Gioni CHIOCCHETTI, Capannori (IT)

(73) Assignee: Valmet Tissue Converting S.p.A., Lucca, LU (IT)

(21) Appl. No.: 18/689,158

(22) PCT Filed: Sep. 2, 2022
(86) PCT No.: PCT/EP2022/074528

§ 371 Date: Mar. 5, 2024

(30) Foreign Application Priority Data
Sep. 7, 2021 (IT) 102021000023120

(51) Int. Cl. B26D 7/02; B26D 1/16; B26D 3/16; B26D 7/01

(52) U.S. Cl. CPC B26D 7/02; B26D 1/16; B26D 3/16; B26D 2007/013; B26D 2210/11

(57) ABSTRACT

The clamping device includes a flexible member extending approximately according to an arc of circumference open at the bottom at a supporting and sliding surface of the logs to be cut. Actuator members are further provided for clamping and releasing the flexible member around the logs to be cut which advance along the feed path through the arc of circumference defined by the flexible member. The actuator members include a first tensioning and release device of the flexible member and a second tensioning and release device of the flexible member. The first tensioning and release device and the second tensioning and release device are adapted to engage two ends of the flexible member, and to increase and reduce the radius of the arc of circumference defined by the flexible member, which extends between the first tensioning and release device and the second tensioning and release device.

### TECHNICAL FIELD

The present invention relates to the field of machines for converting rolls or logs of web material, in particular (but non-exclusively) tissue paper. Embodiments described herein relate to improvements to the clamping devices used in log saws for clamping the rolls or logs during cutting and allow the feeding thereof between one cut and the next cut. Also disclosed is a log saw comprising a clamping device for clamping the logs during cutting.

### BACKGROUND ART

Producing logs of tissue paper starting from large diameter parent reels is known in the tissue paper industry. In the converting line, one or more plies of tissue paper are unwound from one or more parent reels and fed to a rewinding machine. In the rewinding machine, the ply/ies of web material are wound to form rolls or logs of tissue paper in succession, whose axial length is equal to the axial length of the parent reels and whose diameter is equal to the diameter of the final rolls intended for packaging and sale. The logs or rolls formed by the rewinder must subsequently be cut into a plurality of smaller rolls, whose axial dimension is a sub-multiple of the width of the starting plies, i.e. the axial length of the parent reels and of the logs formed by the rewinder.

So-called log saws are known to obtain the final rolls by cutting the logs produced by the rewinder. In these log saws, one or more logs coming from the rewinder (directly or with the interposition of other stations of the converting line, such as a tail sealer and/or an intermediate accumulator), are made to advance and cut into individual logs by means of cutting blades. The cutting blades are usually rotating circular blades, but they may also be band blades. Examples of log saws are disclosed in US2006/162522, EP0555190, EP0507750, WO2008/62488.

To cut the logs, they must be clamped, i.e. held against lateral displacement when the cutting blade penetrates the log. For this purpose, clamping devices have been developed, which hold the logs during cutting, but at the same time allow the ejection of the cut rolls and the advancement of the logs as they are divided into small rolls.

The clamping devices must be flexible, in the sense that they should be adapted to work with logs of variable diameters, according to production needs. Furthermore, it is desirable that they do not damage the rolls and logs during and after cutting, while providing an adequate retention effect of the logs when they are subjected to the thrust exerted by the cutting blade.

Various clamping devices have been developed and studied for this purpose.

For example GB2181984 disclosed a clamping device in which the logs advance along a path, sliding on two symmetrical cradles, pivoting around axes parallel to the feeding path of the logs. The cradles define a supporting and clamping surface for the logs, of an approximately semi-cylindrical concave shape. The supporting surface has a radius of curvature approximately equal to the radius of the logs to be cut. Therefore, whenever the diameter of the logs changes, it is necessary to replace the two cradles, which is a complicated and long intervention that causes a line stoppage and loss of production. To clamp the logs against the semi-circular supporting surface, a belt is provided which surrounds the logs by about 180° in the upper area thereof, i.e. on the semi-cylindrical surface of the logs opposite that which is in contact with the semi-cylindrical concave surface formed by the two cradles. The device therefore requires a large number of moving parts (belt, tilting cradles) to perform the function of clamping the logs to be cut.

EP0526412 discloses a clamping device which comprises a flexible member which wraps around two approximately semi-cylindrical shells, anchored to two pivoting supporting blocks. The two semi-circular shells define an approximately cylindrical volume, through which the roll or log to be cut passes and which may adapt to various log diameters. To obtain the adjustment of the passage size for the logs, the size of the passage formed by the two semi-circular shells may be adjusted by lengthening or shortening a belt which wraps the shells by about 180º. By lengthening or shortening the belt, the shells deform more or less, thus modifying the size of the passage for the logs. For small diameter logs, the two shells partially overlap. This known device, although particularly efficient and capable of adapting to variable diameters of the rolls or logs to be cut, is susceptible of further improvements.

### SUMMARY

According to a first aspect, a clamping device for clamping logs of web material during cutting in a log saw is described herein, which overcomes in whole or in part the drawbacks or limitations of known devices.

In embodiments disclosed herein, the clamping device comprises, for each feed channel of the logs or rolls to be cut, a flexible member extending approximately along an arc of circumference open at the bottom at a supporting and sliding surface of the logs to be cut. Since the logs usually advance along a horizontal path, the flexible member is located in a substantially vertical plane, that is, the arc of circumference defined thereby is substantially located in a vertical plane.

In the present context, as will become apparent from the description of embodiments, the term “arc of circumference” is to be understood in an approximate and not a geometric sense. In fact, the flexible member is arranged according to an arc of circumference in an approximate and not rigorously geometric manner, since such arc may undergo deformations both due to the effect of the own weight of the flexible member, and due to the action of the control mechanism or of other members of the clamping device.

The clamping device further comprises actuator members for clamping and releasing the flexible member around the logs to be cut, which advance along the feed path through the arc of circumference defined by the flexible member. The clamping and release movement may be carried out at each advancement step of the rolls or logs to be cut, or only when, upon completion of the cut of a log or roll, it is necessary to introduce a subsequent log or roll through the flexible member.

Advantageously, the actuator members comprise a first device for tensioning and releasing the flexible member and a second device for tensioning and releasing the flexible member, arranged on opposite sides of the supporting and sliding surface of the logs. Moreover, the first tensioning and release device and the second tensioning and release device are adapted to engage the first end and the second end of the flexible member, and to increase and reduce the radius of the arc of circumference by means of lengthening and shortening of a portion of the flexible member, which extends between the first tensioning and release device and the second tensioning and release device and forms the arc of circumference.

In advantageous embodiments, the first tensioning and releasing device and the second tensioning and releasing device are adapted to impose equal movements at the first end and the second end of the flexible member, so that the median point of the flexible member substantially always remains approximately on the median vertical plane, as the dimension (radius) of the arc of circumference formed by the flexible member varies.

Advantageously, a control mechanism may also be provided, which is constrained to an upper intermediate anchoring point of the flexible member, opposite the supporting and sliding surface of the logs. The control mechanism is adapted to control a movement of the anchoring point toward and away from the supporting and sliding surface of the logs. This movement allows a quick and simple adjustment of the circumference of the flexible member to various diameters of the rolls or logs to be cut.

In order to facilitate the action of the tensioning and releasing devices, which engage the ends of the flexible member, at least in proximity to these ends the flexible member may comprise a toothing on the outer surface thereof. In particularly advantageous embodiments, the flexible member may have a toothing extending throughout the extension thereof. In this case, the flexible member may consist of a portion of a toothed belt.

In some embodiments, the first tensioning and release device comprises a first toothed wheel meshing with the toothing in proximity of the first end of the flexible member, and the second tensioning and release device comprises a second toothed wheel meshing with the toothing in proximity of the second end of the flexible member. A single motor, for example an electric motor, may drive the two toothed wheels, providing a suitable transmission system from the single motor to the two toothed wheels. The possibility of providing two distinct motors, one for each of the two toothed wheels, is not excluded. A control unit may control the movement of the two motors, so that they are symmetrical.

In some embodiments, the first end of the flexible member extends between the first toothed wheel and a first guide that extends around the first toothed wheel and that is configured to maintain the toothing of the first end of the flexible member meshing with the first toothed wheel. Likewise, the second end of the flexible member extends between the second toothed wheel and a second guide that extends around the second toothed wheel and that is configured to maintain the toothing of the second end of the flexible member meshing with the second toothed wheel. Advantageously, the supporting and sliding surface of the logs may be at least partly arranged between the first toothed wheel and the second toothed wheel.

In some embodiments, the first guide comprises a first concave surface extending around the first toothed wheel and defining with the first toothed wheel a first guide channel of the first end of the flexible member; and the second guide comprises a second concave surface extending around the second toothed wheel and defining with the second toothed wheel a second guide channel of the second end of the flexible member. The supporting and sliding surface of the logs may be at least partly arranged between the first concave surface and the second concave surface.

In order to obtain a particularly simple structure, it is possible to provide that the first guide and the second guide form the supporting and sliding surface of the logs at least in the area extending through the flexible member.

In some embodiments, it may be provided that the control mechanism comprises a movable element, constrained to the flexible member at the anchoring point and provided with a movement toward and away from the supporting and sliding surface of the logs. Furthermore, a first actuator may be provided to control the movement toward and away.

According to another aspect, a log saw for cutting logs of web material is disclosed herein; wherein the log saw comprises: a feed path of the logs to be cut; a moving member, for advancing the rolls along the feed path; a blade provided with a cyclic movement along a transversal cutting trajectory with respect to the feed channel, for cutting each log into rolls of axial dimensions smaller than an axial dimension of the logs. Advantageously, the log saw comprises at least a first clamping device as defined above, adjacent to the cutting trajectory. Preferably, the log saw comprises two clamping devices for each feed channel of the log or roll to be cut and more exactly upstream and downstream of a cutting plane, transversal to the axis of the roll or log to be cut.

According to yet another aspect, a method is disclosed for cutting logs of web material with a log saw as outlined above, comprising the following steps:
a. advancing a log to be cut along the feed path and positioning the log with respect to the cutting trajectory;
b. clamping the log to be cut by tensioning the flexible member by means of at least one of said first tensioning and release device and second tensioning and release device;
c. cutting the log by means of the cutting blade;
d. releasing the flexible member around the log by releasing at least one of said first tensioning and release device and second tensioning and release device;
e. advancing the log to be cut by one step, ejecting the cut roll and repositioning the log to be cut with respect to the cutting trajectory;
f. repeating the steps (a) to (e).

Further features and embodiments of the clamping device, of the log saw and of the method described herein are indicated hereinafter and in the appended claims, which are intended to be incorporated in the present description.

In the present description and in the appended claims, the terms “vertical”, “horizontal”, “upper” and “lower”, “above”, “below” and similar terms defining positions in space, refer to the position of the respective members when the log saw is in working mode. The term “vertical” indicates a direction parallel to the force of gravity, while the term “horizontal” indicates a direction orthogonal to the vertical direction.

### BRIEF DESCRIPTION OF THE DRAWINGS

The invention will be better understood by following the description and the accompanying drawings, which illustrate exemplifying and non-limiting embodiments of the invention. More particularly, the drawings show:

FIG. 1 is a schematic side view of a log saw for cutting logs of web material, for example logs of tissue paper;

FIG. 2 a front view of one of the clamping devices of the log saw of FIG. 1 along the line II-II of FIG. 1;

FIG. 3 is a side view according to III-III of FIG. 2;

FIG. 4 is an enlargement of a detail of FIG. 2;

FIGS. 5(A) to 5(I) an operating sequence of a clamping device in one embodiment;

FIGS. 6(A) to 6(H) an operating sequence, in a further embodiment, of a clamping device upstream of the cutting plane; and

FIGS. 7(A) to 7(H) the operating sequence of the clamping device downstream of the cutting plane.

### DETAILED DESCRIPTION

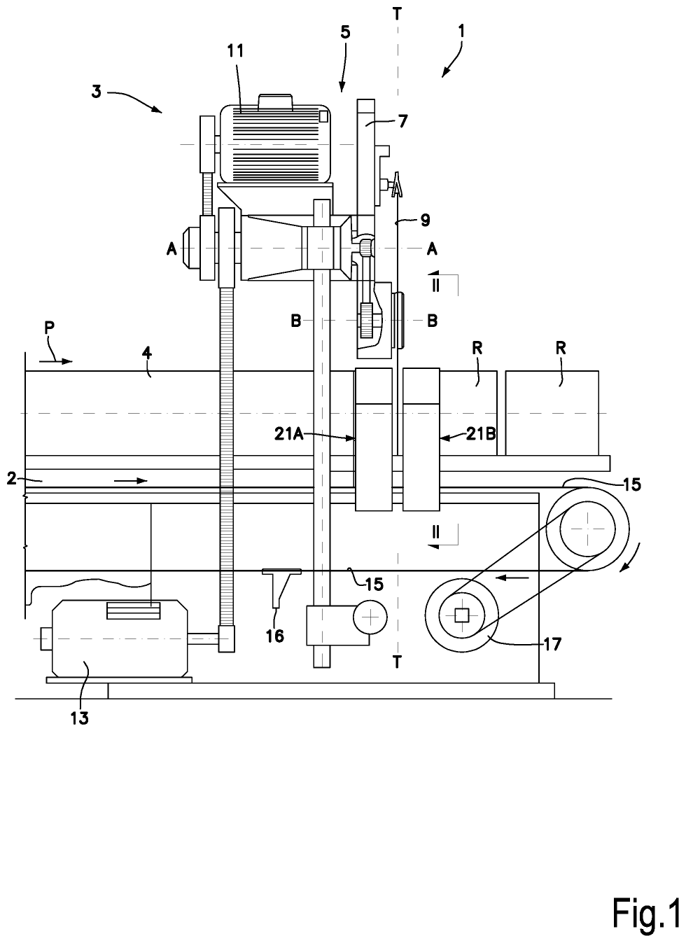

FIG. 1 schematically illustrates the main members of a log saw 1, wherein the invention disclosed herein may be incorporated. It must be understood that the structure of the log saw may differ from that briefly described and illustrated herein. For example, different transmission members may be provided for the feed motion of the logs and the disc-shaped cutting blade. The latter may be provided with a reciprocating motion, for example a reciprocating angular motion, instead of a continuous rotary motion as in the present embodiment, described in greater detail below. Furthermore, the cutting head of the log saw may comprise more than one disc-shaped cutting blade. The use of non-disc-shaped cutting blades, such as band blades, is not excluded. The latter may be particularly suitable for cutting logs of wound web material, whose diameter and compactness are very high, such as for example in so-called industrial logs.

The log saw 1 illustrated herein comprises a feed path schematically indicated with P, consisting of one or more feeding channels 2, along which logs or rolls L, which must be cut to form rolls R of smaller axial dimension than the logs L, are fed. The rolls R are then fed to packaging machines, not shown. The log saw 1 is located downstream of a rewinder and other converting stations, not shown and known to those skilled in the art, for example tail sealers, accumulators, and others.

In some embodiments, the log saw 1 comprises a cutting station 3, which in turn comprises a cutting head schematically indicated with 5. The cutting head 5 may comprise a movable unit 7 carrying one or more disc-shaped cutting blades. The movable unit 7 is provided with a cyclic movement, for example a rotation movement around the rotation axis A-A, which may generally be oriented approximately in the direction of the feed path P of the logs L to be cut along the feeding channel or channels 2. As specified above, in other embodiments, the movable unit 7 may be provided with a reciprocating movement, for example with a reciprocating rotation movement, i.e. oscillation, or with a roto-translation movement. Furthermore, the cutting head 5 may be provided with two movable units 7 offset from each other by an angle ranging from 10° to 180° and each comprising a disc-shaped cutting blade or two coaxial disc-shaped cutting blades.

In the illustrated example, the movable unit 7 of the cutting head 5 carries a disc-shaped cutting blade 9, which can rotate around its own rotation axis B-B. The rotation axis B-B of the disc-shaped cutting blade 9 may generally be oriented approximately in the direction of the axis A-A. As known by those skilled in the art, log saws exist in which the axes A-A and B-B are not perfectly parallel to each other and/or to the feed direction along the feed path P of the logs to be cut. This based on consideration of various features of the log saw, which are not of interest in the present description and which concern the relative movements between the cutting head 5 and the advancement of the logs L to be cut.

The log saw 1 may comprise a motor, typically an electric motor 11, which supplies the rotational motion to the disc-shaped cutting blade 9 around the axis B-B. The log saw 1 also comprises a further motor, typically an electric motor 13, which provides the rotation movement of the cutting head 5 and in particular the cyclic motion of the movable unit 7 around the axis A-A.

Feeding of the logs L along the feeding channel or channels 2 according to the path P may be obtained by means of a moving member. In embodiments, the moving member comprises a continuous flexible member 15, for example a chain or a belt, which may be driven by a motor, typically an electric motor 17. The flexible member 15 may comprise pushers 16 arranged at preferably regular intervals along the extension of the flexible member 15 to push each single log L along the feed channel through the cutting station 3. Typically, each pusher 16 engages a single log L at the rear and pushes it forward along the feed channel or channels 16. In another embodiment, it is possible to advance the logs L by means of a pair of opposing belts which engage the log L on the outer cylindrical surface. For example, the belts may be flat belts. Preferably, the faces of the belts which engage the logs L may be placed approximately vertically on top of each other.

Advantageously, the motors 11, 13 and 17 may be controlled by a central control unit, for example a PLC, a microcomputer, a PC or other, not shown.

In some embodiments, the advancement of the logs L may be intermittent. During idle periods, the log L is cut by the disc-shaped cutting blade 9. In other embodiments, the advancement may be continuous, at constant or variable speed. In this case, the movable unit 7 and/or the disc-shaped cutting blade 9 may be provided with a forward and backward movement along the path P to cut the log L while the latter advances along the feed path P without stopping.

The log saw 1 comprises clamping devices for holding the log L during cutting. In the illustrated embodiment, the log saw 1 comprises, for each feed channel 2 of the logs L to be cut, two clamping devices, indicated with 21A and 21B, respectively placed upstream and downstream of a cutting plane indicated with T-T and which consists of the plane of the disc-shaped cutting blade 9.

The clamping devices 21A, 21B may be equal to each other or symmetrical with respect to the cutting plane T-T. Hereinafter, embodiments of the clamping devices 21A, 21B will be described. Since these devices are substantially the same or symmetrical, the structure of only one of them will be described, generally referred to as the clamping device 21, and the description may refer both to the clamping device 21A and to the clamping device 21B. In some embodiments, as will become apparent from the detailed description that follows, the two clamping devices 21A, 21B may be structurally the same, or symmetrical, or in any case similar to each other, but controlled so as to perform slightly different sequences of movements from each other.

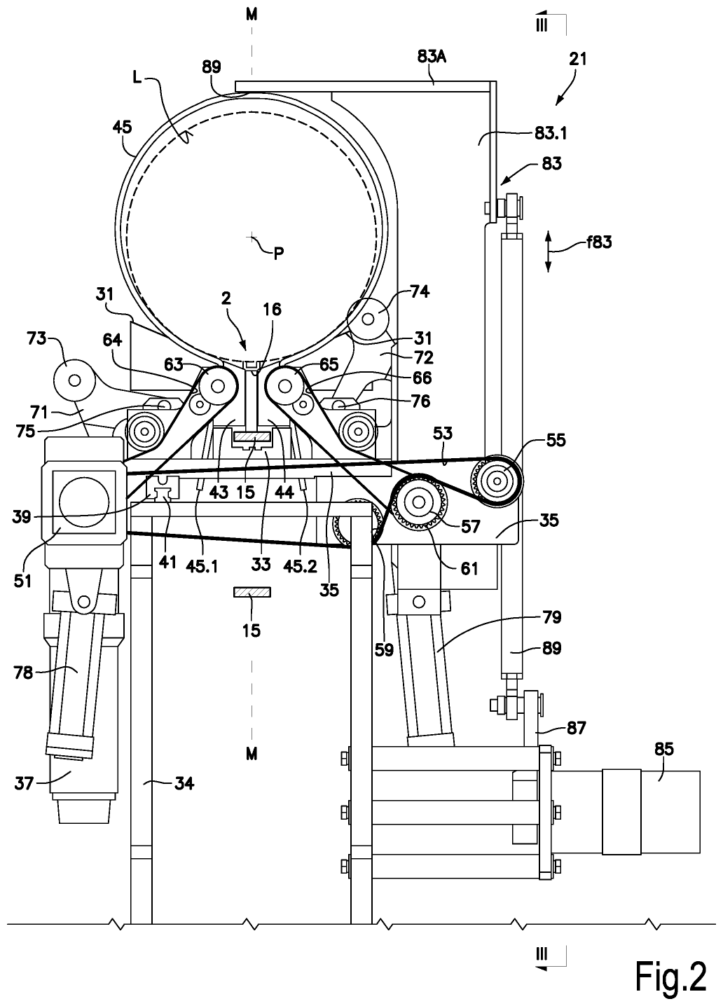

The structure of one of the clamping devices, generally indicated with 21, is illustrated in detail in FIGS. 2, 3 and 4. FIG. 2 shows an enlarged detail in a view according to line II-II of FIG. 1 of the clamping device 21. It should be understood that the log saw 1 may have more than one feed channel 2 for the logs L to be cut and that each channel comprises advancing members 15, 16. The reference number 31 indicates two support surfaces which define, for each feed channel 2 of the logs L to be cut and of the rolls R obtained by cutting the logs L, a supporting and sliding surface of the logs L and of the rolls R. The supporting structure is V-shaped and is interrupted centrally, i.e. at the vertex, at a median plane M-M, to allow the passage of the pushers 16 constrained to the flexible member 15.

In the diagram of FIG. 2, the upper branch of the flexible member 15 is guided in a guide 33, wherein the lower ends (constrained to the continuous flexible member 15) of the pushers 16 are also guided.

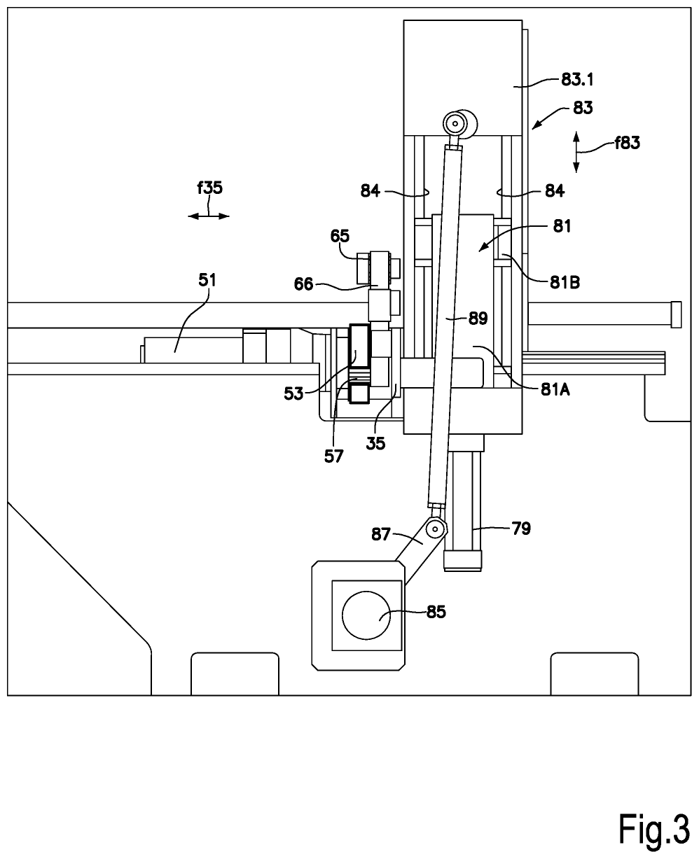

In some embodiments, a slide 35 is carried on a bearing structure 34, to which the guide 33 may be constrained. The slide 35 may have a horizontal movement parallel to the path P of the logs L to be cut. The movement, indicated by the double arrow f35, FIG. 3, may be imparted by an actuator 37, for example an electric motor. To carry out the movement according to f35, the slide 35 is guided by guides 41 (only one of which is visible in FIG. 2) integral with the bearing structure 34, to which runners 39 integral with the slide 35 are engaged. The movement f35 imparted to the slide 35 by the motor 37 may serve to adjust the position of the clamping device 21, of which the slide forms a part, with respect to the cutting plane T-T. The movement f35 of the slide 35 may also be advantageously performed in a synchronized manner with the cutting motion of the disc-shaped blade 9 to reduce the friction between the disc-shaped cutting blade 9 and the log L. In fact, the disc-shaped cutting blade 9 has a conical or biconical shape, i.e. it has a variable thickness from the cutting edge towards the rotation axis B-B. Therefore, the penetration of the disc-shaped cutting blade 9 into the log L causes a lateral compression of the material of which the log L is made, with a consequent strong increase in the friction force between the disc-shaped cutting blade 9 and the material of the log. This friction is greater the more worn the disc-shaped cutting blade 9 is, i.e. the smaller its diameter, which is reduced during use due to frequent sharpening operations.

By providing at least and preferably both clamping devices 21A, 21B with a movement f35 parallel to the feeding direction of the logs L along the feed path P, it is possible to move the two clamping devices 21A, 21B away from each other during cutting, i.e. when the disc-shaped cutting blade 9 penetrates the log L, moving the two faces of the material, of which the log L is made, away from each other and from the opposite faces of the cutting blade 9. This effectively reduces the pressure exerted by the material of the log L on the disc-shaped cutting blade 9. The reciprocal spacing and approaching movement of the two clamping devices 21A, 21B may be adjusted as a function of the diameter of the disc-shaped cutting blade 9. Since, as indicated, the disc-shaped cutting blade 9 has a variable thickness, minimum on the cutting edge and maximum in proximity to the rotation axis B-B, the reciprocal distancing stroke of two clamping devices 21A, 21B may be as much greater as the more the disc-shaped cutting blade 9 is worn, that is, the greater the thickness of the portion of the disc-shaped cutting blade 9 which penetrates the log L to cut it.

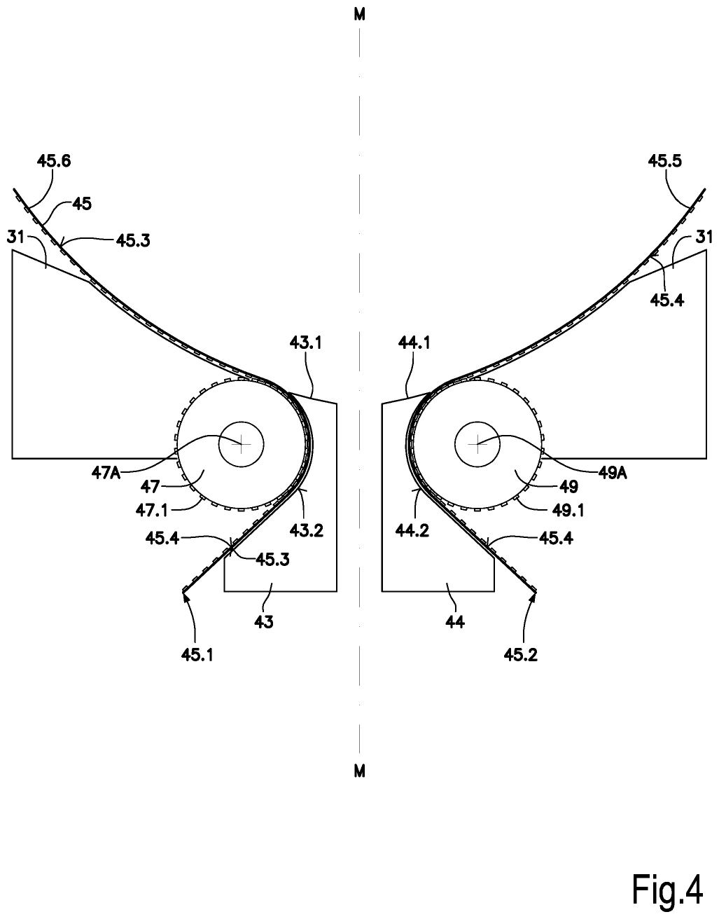

Two blocks 43, 44 symmetrical with respect to the median plane M-M and visible in detail in the schematic enlargement and with removed parts of FIG. 4 are integral with the slide 35. Each block 43, 44 has an approximately flat upper surface 43.1, 44.1. The two upper surfaces 43.1 and 44.1 of the blocks 43, 44 form a supporting and sliding surface for the logs L and the rolls R, aligned with the supporting and sliding surface formed by the supporting planes 31. Each block 43, 44 also forms a concave cylindrical surface 43.2, 44.2 which defines a guide for a respective end of a flexible member 45. The flexible member 45 may be formed by an open, i.e. non-continuous belt, which comprises a first end 45.1 and a second end 45.2. The flexible member 45 is arranged according to an arc of circumference much greater than 180°, preferably a little less than 360°, i.e. forming almost a closed circumference, but with an interruption in the lower area, along the median plane M-M, which allows the passage of the pushers 16. For example, the arc of circumference formed by the flexible member 45 may have an extension greater than 300°, preferably greater than 320° or even greater than 330°. For example, the arc of circumference may have an extension of between 320° and 355°, preferably between about 330° and about 355°. In this way, the flexible member 45 forms a lower support for the log L to be cut and exerts a radial clamping force around the log for almost the entire circumferential extension thereof, contrary to what happens in prior art devices, where a belt wraps only the upper part of the log to be cut, for an arc of about 180°, and presses the log against the underlying, interchangeable cradles, which constitute the guide members of the log and contrast surfaces, to obtain the clamping of the log between the cradles and the belt.

As will become apparent from the description of the operation of the device, in practice the flexible member 45 embraces the log itself, tightening it and locking it with the inner surface 45.3 in contact with the log, by virtue of fact that the continuous flexible member 45 forms a loop around the log L.

The two ends 45.1, 45.2 of the flexible member 45 extend under the upper surfaces 43.1, 44.1 of the blocks 43, 44 and fit into respective guide channels defined between the respective concave cylindrical surface 43.2, 44.2 and a respective wheel 47, 49, rotatable around a horizontal axis 47A, 49A, parallel to the feed path P of the logs L. The wheels 47, 49 are visible in particular in the detail of FIG. 4. The wheels 47, 49 with the respective rotation members form two tensioning and release devices for lengthening and shortening the portion of the flexible member, which forms the arc of circumference formed by the flexible member 45. As will be described below, the tensioning and release members are adapted to perform symmetrical movements, so that the flexible member extends or shortens by equal lengths on the two sides of the median plane M-M. Basically, in the illustrated embodiment, the two wheels 47, 49 perform rotations in opposite directions (i.e. one clockwise and the other anti-clockwise) by the same extent, i.e. by the same number of degrees. In this way, the portion of flexible member 45 which forms the arc of circumference increases or decreases in radius, maintaining its midpoint on the median plane M-M.

The wheels 47, 49 constitute tensioning and release devices of the flexible member 45, as clarified hereinafter.

The flexible member 45 comprises an inner surface 45.3 and an outer surface 45.4. The inner surface 45.3 defines the intrados of the arc of circumference formed by the flexible member 45, while the outer surface 45.4 defines the extrados of the arc of circumference formed by the flexible member 45. The inner surface 45.3 is a contact surface with the logs to be cut and, as will become apparent from what is described below, it exerts a clamping force directly on the log, without elements interposed between the flexible member 45 and the cylindrical outer surface of the log L.

In embodiments, a toothing 45.5 is formed on the outer surface 45.4 of the flexible member 45, comprising a plurality of teeth arranged in sequence. The toothing 45.5 may extend only for part of the flexible member 45, i.e. along a portion starting from each end 45.1, 45.2. Preferably, however, the toothing extends over the entire longitudinal extension of the flexible member 45, that is, from the first end 45.1 to the second end 45.2. In this way, the flexible member 45 may consist of a commercially available toothed belt.

When the outer surface 45.3 of the flexible member 45 is provided with a toothing 45.5, the wheels 47, 49 are also toothed, with teeth 47.1, 49.1 meshing with the toothing 45.6 of the two terminal portions adjacent to the ends 45.1, 45.2 of the flexible member 45. In practice, by virtue of the concave cylindrical guide surfaces 43.2, 44.2 and the toothed wheels 47, 49, the ends 45.1, 45.2 of the flexible member 45 are in engagement with the teeth 47.1, 49.1 of the toothed wheels 47, 49. These ends 45.1, 45.2 of the flexible member 45 are substantially inserted in guide channels defined respectively: by the first toothed wheel 47 and by the concave cylindrical surface 43.2; and by the second toothed wheel 49 and by the concave cylindrical surface 44.2.

The rotation of the toothed wheels 47, 49 in discordant directions causes the lengthening and shortening of the portion of the flexible member 45, which forms the arc of circumference overlying the surfaces 43.1, 44.1 of the blocks 43, 44.

Since the arc of circumference formed by the flexible member 45 almost completely surrounds the log L, which advances along the path P of the log saw 1, acting on the toothed wheels 47, 49 and making them rotate in discordant directions (i.e. one in a clockwise direction and the other in an anti-clockwise direction), it is possible to tension and release the flexible member 45 around the log or roll L for the purposes which will become apparent from the description of the operation of the clamping device 21, set forth later on.

The rotation of the toothed wheels 47, 49 is imparted by an actuator 51, for example an electric motor, shown in particular in FIGS. 2 and 3. The motion of the motor 51 is transmitted to a belt 53, preferably a toothed belt, guide around toothed pulleys 55, 57, 59 supported idle on the slide 35. The pulley 57 is coaxial to the pulley 61. A belt, preferably a toothed belt, labeled 66, which moves a pulley 65 coaxial to the toothed wheel 49 and rigidly connected thereto, is guided around the pulley 61. A further belt 64, preferably a toothed belt, takes motion from the motor 51 and transmits it to a pulley 63 coaxial to the toothed wheel 47 and rigidly connected to it.

In practice, the system of belts and pulleys 53-66 described above transmits the rotation motion from the actuator 51 to the two toothed wheels 47, 49 in such a way that the two toothed wheels perform equal rotations but in opposite directions.

In some embodiments, pivoting arms 71, 72 are supported on the slide 35, hinged around horizontal axes 75, 76, parallel to the feed path P of the logs L. At the distal ends, the pivoting arms 71, 72 carry respective rollers 73, 74, adapted to form outer supports for the flexible member 45. The pivoting arms 71, 72 are controlled by actuators, for example cylinder-piston actuators 78, 79, to alternatively take an inactive position and an active position. Actually, the two arms 71, 73 are always positioned in symmetrical positions with respect to the median plane M-M. However, in FIG. 2 the pivoting arm 71 is shown in the inactive position, distant from the flexible member 45, while the pivoting arm 72 is shown in the active position with the respective roller 74 resting on the outer surface 45.4 of the flexible member.

The rollers 73, 74 constitute auxiliary supports for the flexible member 45 during cutting of the logs L. In some cases, the rollers 73, 74 may be omitted. If present, they may always be brought into the active position, or only when necessary, for example for cutting logs of particularly large diameters.

On the slide 35 there are also supported guide means 81 fixed with respect to the slide 35, on which a control mechanism 83 slides with a vertical movement according to the double arrow f83. The control mechanism 83 comprises a movable element comprising an upright 83.1, with which a transverse element 83A connected to the flexible member 45 is integral. The upright 83.1 and the transverse element 83A form a movable element moving according to the double arrow f83 for the purposes described below.

The movement of the control mechanism 83 and more particularly of the movable element formed by the upright 83.1 and the transverse element 83A, is controlled by an actuator 85, for example an electric motor. In the illustrated embodiment, the movement is transmitted from the actuator 85 to the movable element 83.1, 83A by means of a transmission comprising a crank 87 and a connecting rod 89. In other embodiments, the movement to the control mechanism 83 may be imparted by a linear rather than a rotary motor, thereby omitting the connecting rod-crank transmission.

In the illustrated embodiment, as visible in FIG. 3, the guide means 81 comprise a beam 81A, which may be integral with the slide 35 and which carries runners 81B. The runners 81B engage on guides 84 integral with the control mechanism 83, more precisely with the upright 83.1, and extend in the vertical direction.

In this embodiment, the upright 83.1 of the control mechanism 83 has a vertical extension and ends at the top with the transverse element 83A, rigidly connected to the upright 83.1, which extends up to the median plane M-M, where the distal end of the transverse element 83A of the control mechanism 83 is constrained in an upper intermediate anchoring point 89 of the flexible member 45. The upper intermediate anchoring point 89 is substantially located on the median plane M-M.

The flexible member 45 of each of the two clamping devices 21A, 21B serves to laterally block the log L during cutting and to allow the advancement of the log L between one cut and the next. The flexible members 45 are also adapted to allow the ejection of the rolls R obtained from the cutting of the log L and the insertion of consecutive logs L.

Furthermore, the arrangement described above allows the diameter of each flexible member 45 of the two clamping devices 21A, 21A to be adapted to logs L of variable diameters.

In summary, by acting on the toothed wheels 47, 49 it is possible to increase and decrease the length of the portion of the flexible member 45, which forms the arc of just under 360° through which the log L advances. The anchoring point 89 may be moved upwards and downwards through the movement f83 of the control mechanism 83 and more particularly of the upright 83.1 and of the relative transverse element 83A.

A first purpose of the movements mentioned above is to adapt the size of the arc formed by each flexible member 45 to the diameter of the log L to be cut. Thus, the clamping device may be adjusted, quickly and with simple commands from a control panel, to even very different diameters of the log to be cut. The adaptation is obtained by acting on the actuators 51 and 85. Contrary to what happens in devices of the prior art, it is possible to adapt the clamping device to logs of variable diameters even in a relatively wide range, without the need to replace mechanical members, such as supporting and sliding cradles.

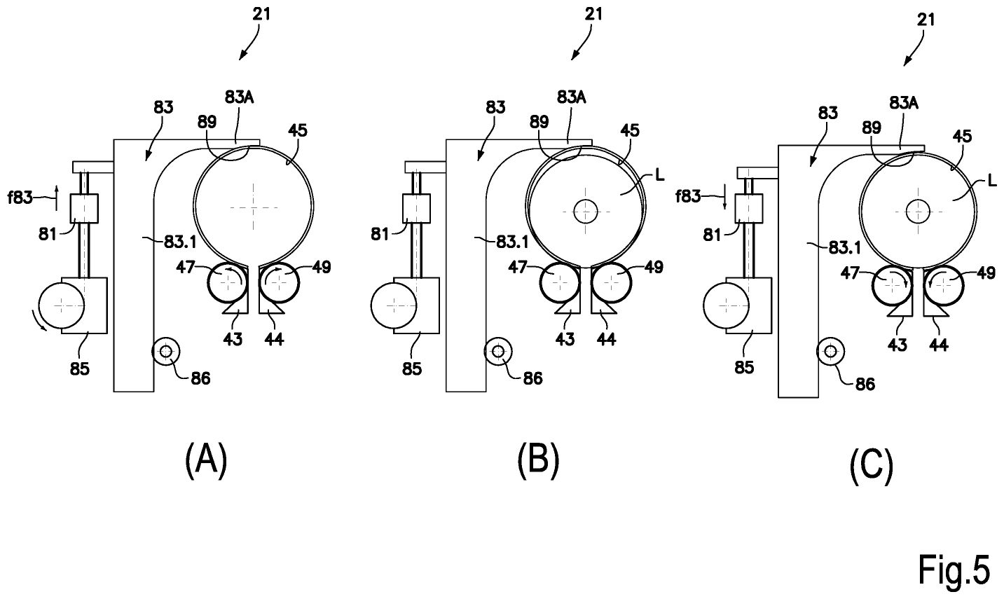

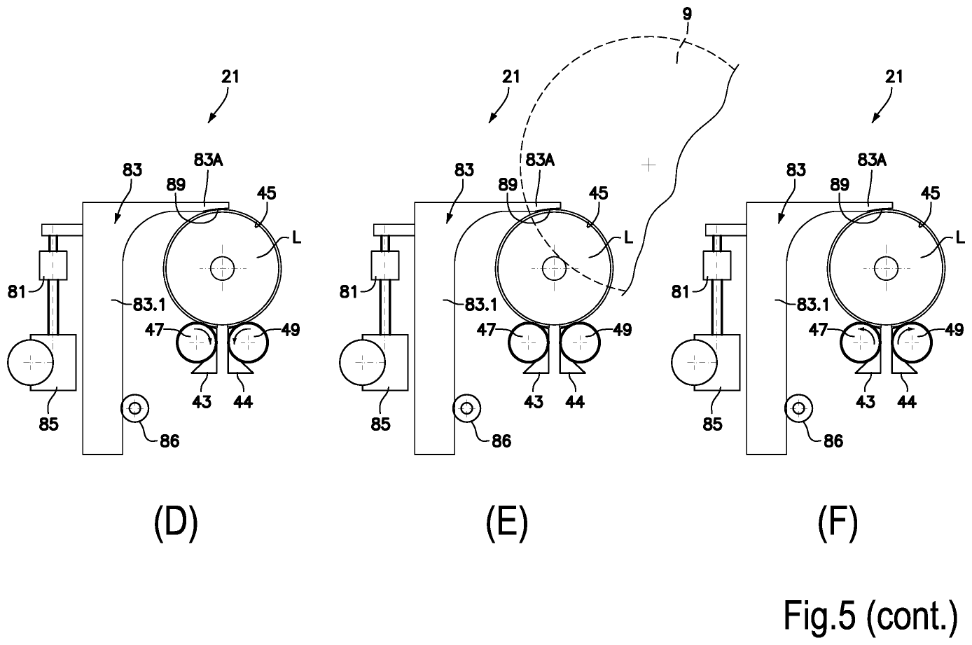

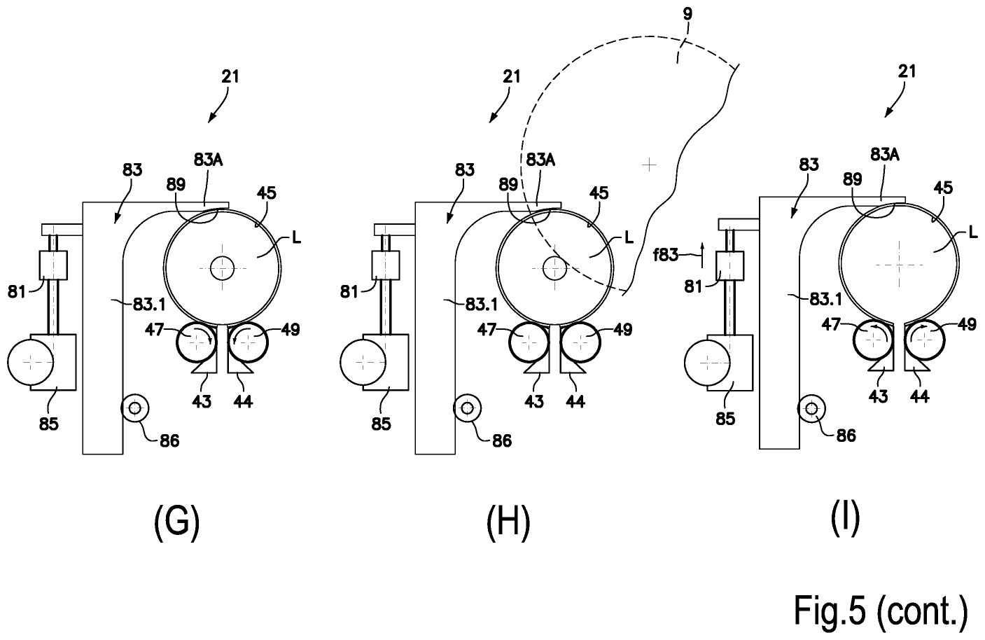

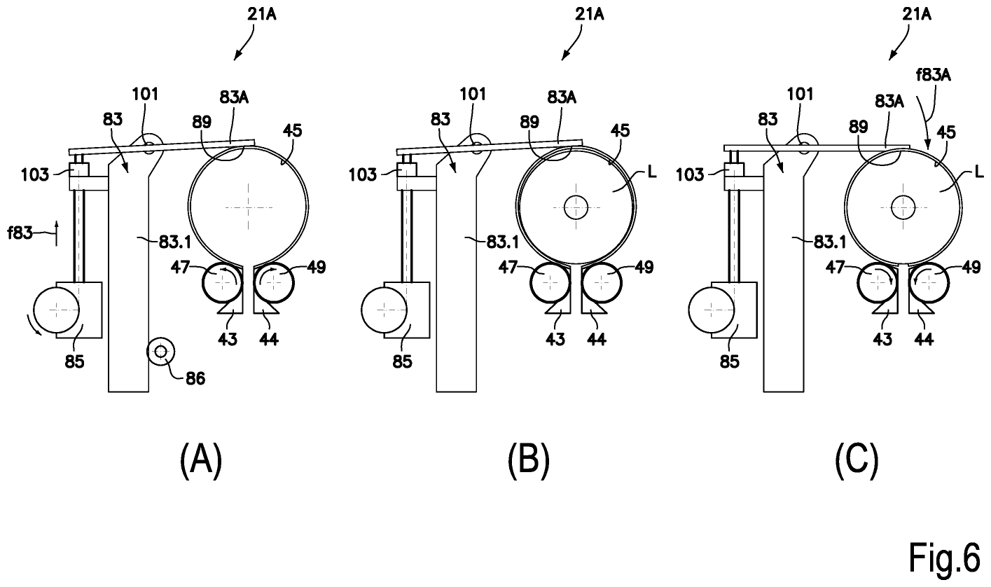

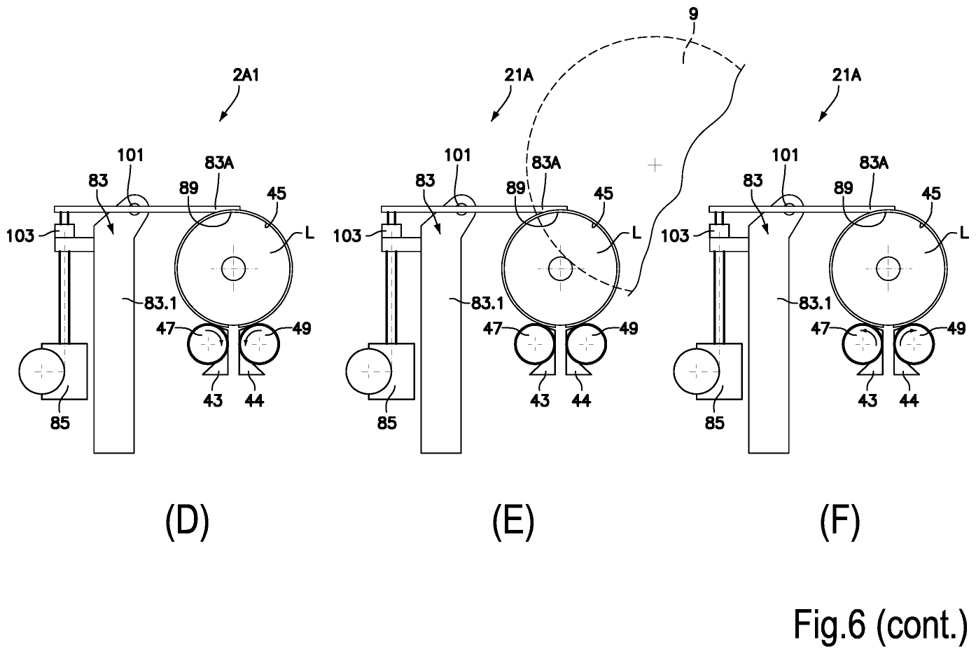

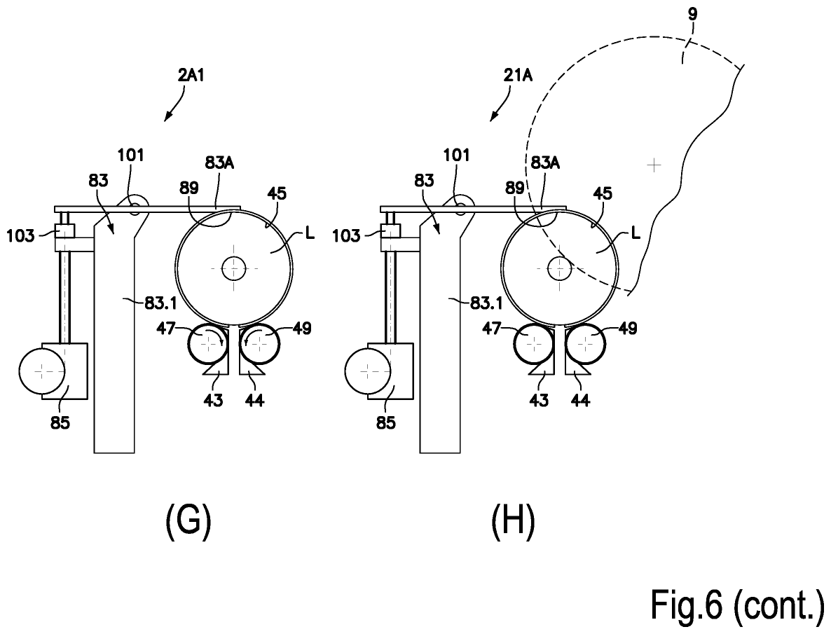

As will be described with reference to the sequences of FIGS. 5 and 6, the movements imparted by the actuators 51, 85 also make it possible to slightly modify the dimension of the arc formed by the flexible member 45 during the cutting of the logs L to facilitate the following operations: insertion of a new log L to be cut through the arc; stepwise advancement of the log L between one cut and the next; ejection of the cut rolls R.

A possible operative sequence of the clamping devices 21A, 21B is schematically illustrated in FIGS. 5(A) to 5(H). In this sequence, the control mechanism 83 and its actuation and guiding system are represented in a schematic and slightly different way compared to the constructive embodiment illustrated in FIGS. 2 and 3, for reasons of simplicity of representation and to show that these members may also take configurations different from those illustrated in FIGS. 2 and 3. More specifically, in the schematic representation of FIGS. 5(A) to 5(H), the control mechanism 83 is indicated as being integral with a bar having a vertical movement f83 controlled by an actuator 85. Reference numeral 86 indicates an encoder or other position sensor, which detects the position of the control mechanism 83.

In the embodiment to which the sequence of FIGS. 5(A) to 5(H) refers, the two clamping devices 21A, 21B move in the same way and therefore these figures may refer indifferently to one or the other of the two clamping devices 21A, 21B, which is why in these figure the clamping device is generically indicated with 21.

The sequence of FIGS. 5(A) to 5(H) shows the movement performed by the clamping device 21 in the step of introducing a new log L to be cut and in the step of performing the cut.

Preliminarily, the dimension of the arc formed by the flexible member 45 has been adapted to the diameter of the logs L to be cut by means of suitable movements of the actuators 51 and 85.

FIG. 5(A) shows the step in which the clamping device 21 prepares to receive a new log L to be cut. In this figure, the control mechanism 83 is raised (arrow f83) to move the anchoring point 89 away from the supporting and sliding surface of the logs L along the feed path. The toothed wheels 47, 49 rotate in the indicated direction to increase the length of the portion of flexible member 45 forming the arc overlying the blocks 43, 44. In practice, the portion of flexible member 45 overlying the blocks 43, 44 is arranged approximately according to an arc of circumference with a diameter slightly larger than the diameter of the log which must be inserted through the arc itself.

In FIG. 5(B), a log L has been inserted through the arc formed by each flexible member 45 of the two clamping devices 21A, 21B. This figure shows the difference between the diameter of the log L and the diameter of the arc formed by the flexible member 45. The insertion of the log L brings the latter into the cutting position, with the portion to be cut by the rotating disc-shaped blade 9 positioned between the two clamping devices.

In the next step, illustrated in FIG. 5(C), the control mechanism 83 is lowered according to the arrow f83, and the toothed wheels 47, 49 recover the excess length of the flexible member 45, causing a reduction in the diameter of the arc formed by the flexible member 45. At the end of this operation, the diameter of the arc formed by the flexible member 45 (and more precisely the inner diameter of said arc) is approximately equal to the diameter of the log L.

Before cutting the log L, the latter is tightened, acting on the toothed wheels 47, 49, as shown in FIG. 5(D), so as to block the log L, preventing it from moving laterally under the thrust of the disc-shaped cutting blade 9.

FIG. 5(E) shows the cutting step, with the disc-shaped cutting blade 9 (indicated in broken lines) which penetrates the log L passing between the two clamping devices 21A, 21B.

In the following FIG. 5(F), the two toothed wheels 47, 49 rotate so as to slightly loosen the respective flexible member 45, so that the log L and the cut roll R may advance through the two arcs formed by the flexible members 45 of the two clamping devices 21A, 21B. The cut roll R is ejected from the log saw, while the log L is repositioned for the next cut.

In FIG. 5(G), the toothed wheels 47, 49 rotate to tighten the respective flexible member 45 again around the log L.

In FIG. 5(H), a new cut of the log is performed, while in FIG. 5(I), the toothed wheels 47, 49 loosen the flexible member 45 again and the control mechanism 83 rises (arrow f83) to widen the arc formed by the flexible member 45 and facilitate the introduction of a new log, while the last log (and any tail trim) is ejected from the log saw.

In practice, the sequence from FIG. 5(D) to 5(H) is repeated until the log L has been cut entirely. The number of cuts to be made on the log L is variable and depends on both the length of the log L and the length of the rolls R to be produced. The first and last cut may be used to eliminate trimmings from the head and tail of the log.

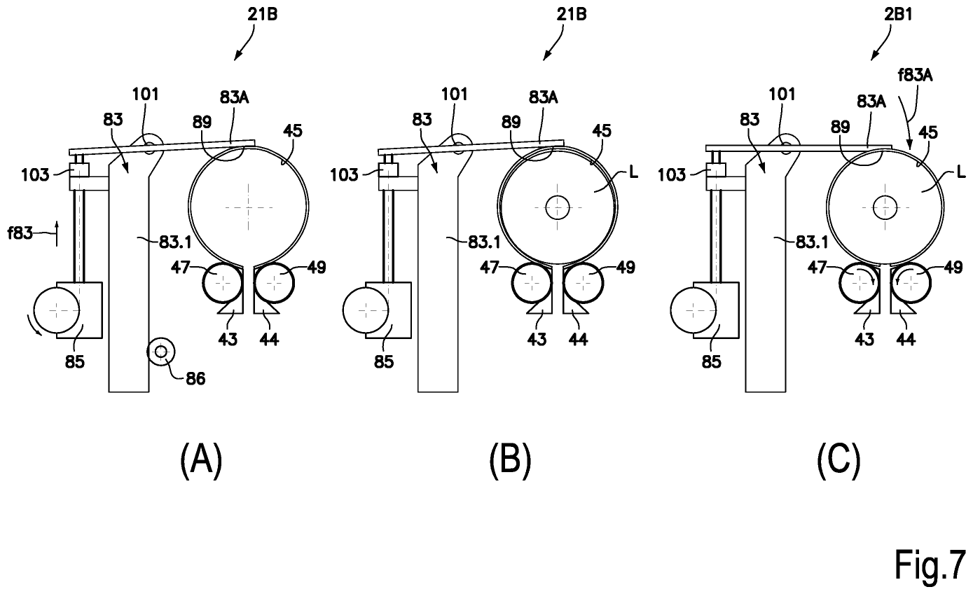

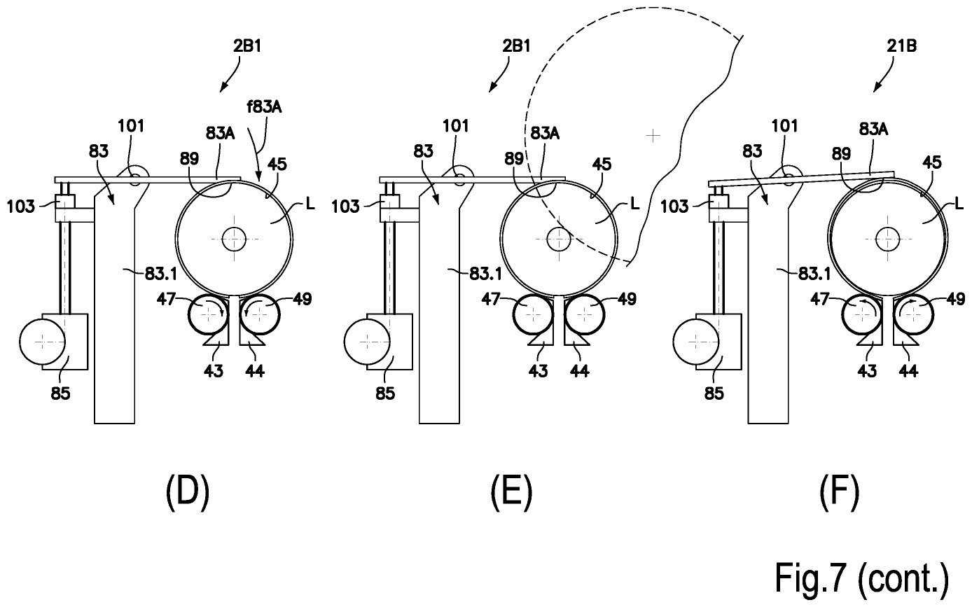

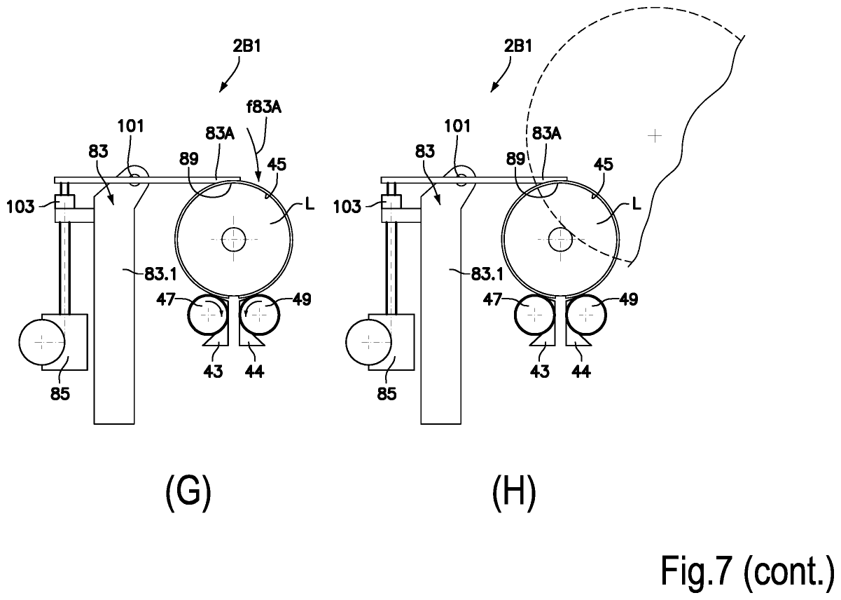

FIGS. 6 and 7 show the operating sequence of the two clamping devices 21A, 21B in an embodiment in which the latter perform slightly different movements relative to each other. The two clamping devices are substantially the same or symmetrical to each other, but slightly different with respect to the devices 21, 21A, 21B described with reference to the above FIGS. 1 to 5.

In fact, in the embodiment schematically shown in FIGS. 6 and 7, the transverse element 83A is not rigidly connected to the upright 83.1 of the control mechanism 83, but is hinged at 101 to the upright 83.1 to perform pivoting movements around the hinge 101, controlled by an actuator 103. In this way, it is possible to move just the transverse element 83A during the various cutting steps and to raise and lower the entire control mechanism 83 only to adjust the clamping device 21A, 21B to the desired diameter and possibly to open and close the clamping device 21A, 21B during the ejection of the last cut log and insertion of a new log.

The sequence of FIGS. 6(A) to 6(H) shows the movements performed by the various parts of the clamping device 21A located upstream of the cutting plane on which the rotating disc-shaped cutting blade 9 moves. The sequence of FIGS. 7(A) to 7(H) shows the movements performed by the various parts of the clamping device 21A located upstream of the cutting plane on which the rotating disc-shaped cutting blade 9 moves.

With initial reference to the sequence of FIGS. 6(A)-6(H), in FIG. 6(A) the device 21A is being prepared for receiving a new log L to be cut. The entire control mechanism 83 is raised, while the transverse element 83A is in the position of maximum rotation in the anti-clockwise direction and held in this position by the actuator 103, for example a cylinder-piston actuator.

The new log L is inserted into the arc formed by the flexible member 45, as shown in FIG. 6(B) and the combined movements of the transverse element 83A (rotation according to f83A) and of the toothed wheels 47, 49 narrow the arc formed by the flexible member 45 until it comes into contact with the new log L, see FIG. 6(C).

At this point, the sequential cutting operations of the log L into rolls R are carried out, with tightening and loosening movements of the flexible member 45 by the toothed wheels 47, 49 alone, while the transverse element 83A and the entire control mechanism 83 remain substantially stationary. In FIG. 6(D), the tightening with rotation of the wheels 47, 49 is performed; in FIG. 6(E), the cut is performed, see the blade 9 illustrated in broken lines; in FIG. 6(F), the flexible member 45 is loosened to allow the log L to slide forward; in FIG. 6(G), a second cut is made.

FIGS. 7(A) to 7(G) show the movements of the same members and components of the clamping device 21B in the same steps described above and shown in FIGS. 6(A) to 6(G). The difference between the two sequences concerns step (F). In the clamping device 21B, which is located downstream of the cutting plane T-T, between one cut and the next [i.e. between FIG. (E) and FIG. 7(G)], the transverse element 83A is raised to facilitate the ejection of the cut roll R.

1-22. (canceled)

23. A clamping device for clamping logs of web material during cutting in a log saw, the clamping device comprising:
a flexible member extending approximately according to an arc of circumference open at a bottom at a supporting and sliding surface of the logs to be cut; wherein the flexible member comprises a first end, a second end, an inner surface defining an intrados of the arc of circumference, and an outer surface defining an extrados of the arc of circumference;
actuator members for clamping and releasing the flexible member around the logs to be cut, which advance along a feed path through the arc of circumference defined by the flexible member;
wherein the actuator members comprise a first tensioning and release device of the flexible member and a second tensioning and release device of the flexible member;
wherein the first tensioning and release device and the second tensioning and release device are adapted to engage the first end and the second end of the flexible member, respectively, and to increase and reduce a radius of the arc of circumference by lengthening and shortening of a portion of the flexible member, which extends between the first tensioning and release device and the second tensioning and release device and forms the arc of circumference.

24. The clamping device of claim 23, wherein the flexible member is arranged wherein the arc of circumference extends for more than 180°, forming a lower supporting surface for the logs to be cut.

25. The clamping device of claim 23, wherein the flexible member is arranged wherein the arc of circumference extends for more than 300°, forming a lower supporting surface for the logs to be cut.

26. The clamping device of claim 23, wherein the first tensioning and release device and the second tensioning and release device are configured to carry out symmetrical movements.

27. The clamping device of claim 23, further comprising a control mechanism which is constrained to an upper intermediate anchoring point of the flexible member, opposite the supporting and sliding surface of the logs; and wherein the control mechanism is adapted to control a movement of the anchoring point toward and away from the supporting and sliding surface of the logs.

28. The clamping device of claim 23, wherein at least in proximity of the first end and of the second end the flexible member comprises a toothing on an outer surface thereof.

29. The clamping device of claim 28, wherein the first tensioning and release device comprises a first toothed wheel meshing with the toothing in proximity of the first end of the flexible member, and the second tensioning and release device comprises a second toothed wheel meshing with the toothing in proximity of the second end of the flexible member.

30. The clamping device of claim 29, wherein:
the first end of the flexible member extends between the first toothed wheel and a first guide that extends around the first toothed wheel and that is configured to maintain the toothing of the first end of the flexible member meshing with the first toothed wheel;
the second end of the flexible member extends between the second toothed wheel and a second guide that extends around the second toothed wheel and that is configured to maintain the toothing of the second end of the flexible member meshing with the second toothed wheel; and
the supporting and sliding surface of the logs is at least partly arranged between the first toothed wheel and the second toothed wheel.

31. The clamping device of claim 30, wherein:
the first guide comprises a first concave surface extending around the first toothed wheel and defining with the first toothed wheel a first guide channel of the first end of the flexible member;
the second guide comprises a second concave surface extending around the second toothed wheel and defining with the second toothed wheel a second guide channel of the second end of the flexible member; and
the supporting and sliding surface of the logs is at least partly arranged between the first concave surface and the second concave surface.

32. The clamping device of claim 30, wherein the first guide and the second guide at least partly form the supporting and sliding surface of the logs.

33. The clamping device of claim 27, wherein the control mechanism comprises:
a transverse element, constrained to the flexible member in the anchoring point and provided with a movement toward and away from the supporting and sliding surface of the logs; and
a first actuator adapted to control the movement toward and away from said supporting and sliding surface.

34. The clamping device of claim 33, wherein the transverse element comprises an approximately vertical upright, positioned at a side of the flexible member and movable vertically with respect to the supporting and sliding surface.

35. The clamping device of claim 34, wherein the approximately vertical upright is controlled to move vertically under control of the first actuator.

36. The clamping device of claim 35, wherein the approximately vertical upright is associated with a position sensor to detect a position of the approximately vertical upright in vertical direction.

37. The clamping device of claim 33, wherein the transverse element is movably connected to the flexible member.

38. The clamping device of claim 37, further comprising a second actuator to move the transverse element with respect to the approximately vertical upright, movement of the transverse element with respect to the approximately vertical upright causing a movement of the anchoring point toward and away from the supporting and sliding surface of the logs.

39. The clamping device of claim 23, wherein the actuator members comprise at least one actuator associated with at least one of the first tensioning and release device and the second tensioning and release device to tension the flexible member.

40. A log saw for cutting logs of web material; wherein the log saw comprises:
a feed path of logs to be cut;
an advancing member, for advancing the logs along the feed path;
a blade provided with a cyclic movement along a cutting trajectory transverse with respect to the feed path, to cut each log into rolls of an axial dimension smaller than an axial dimension of the logs;
at least a first clamping device comprising:
a flexible member extending approximately according to an arc of circumference open at a bottom at a supporting and sliding surface of the logs to be cut; wherein the flexible member comprises a first end, a second end, an inner surface defining an intrados of the arc of circumference, and an outer surface defining an extrados of the arc of circumference;
actuator members for clamping and releasing the flexible member around the logs to be cut, which advance along the feed path through the arc of circumference defined by the flexible member; wherein the actuator members comprise a first tensioning and release device of the flexible member and a second tensioning and release device of the flexible member; wherein the first tensioning and release device and the second tensioning and release device are adapted to engage the first end and the second end of the flexible member, respectively, and to increase and reduce a radius of the arc of circumference by lengthening and shortening of a portion of the flexible member, which extends between the first tensioning and release device and the second tensioning and release device and forms the arc of circumference.

41. The log saw of claim 40, further comprising a second clamping device comprising:
a second flexible member extending approximately according to an arc of circumference open at the bottom at a supporting and sliding surface of the logs to be cut; wherein the second flexible member comprises a first end, a second end, an inner surface defining an intrados of the arc of circumference, and an outer surface defining an extrados of the arc of circumference;
second actuator members for clamping and releasing the second flexible member around the logs to be cut, which advance along the feed path through the arc of circumference defined by the second flexible member;
wherein the second actuator members comprise a first tensioning and release device of the second flexible member and a second tensioning and release device of the second flexible member; wherein the first tensioning and release device of the second flexible member and the second tensioning and release device of the second flexible member are adapted to engage the first end and the second end of the second flexible member, respectively, and to increase and reduce the radius of the arc of circumference by lengthening and shortening of a portion of the second flexible member, which extends between the first tensioning and release device of the second flexible member and the second tensioning and release device of the second flexible member and forms the arc of circumference;
wherein the first clamping device and the second clamping device are arranged, respectively, upstream and downstream of the cutting trajectory with respect to a direction of advance of the logs along the feed path.

42. A method for cutting logs of web material with a log saw according to claim 40; wherein the method comprises steps as follows:
(a) advancing a log to be cut along the feed path and positioning the log with respect to the cutting trajectory;
(b) clamping the log to be cut by tensioning the flexible member by at least one of said first tensioning and release device and the second tensioning and release device;
(c) cutting the log by the cutting blade;
(d) releasing the flexible member around the log by releasing at least one of said first tensioning and release device and the second tensioning and release device;
(e) advancing the log to be cut by one step, ejecting the cut log and repositioning the log to be cut with respect to the cutting trajectory;
(f) repeating steps (a) to (e).

43. The method of claim 42, wherein the clamping the log to be cut and the releasing the flexible member are carried out by the first tensioning and release device and the second tensioning and release device acting symmetrically.

44. The method of claim 42, further comprising,
at the end of the cutting of the log, releasing the flexible member by the first tensioning and release device and the second tensioning and release device, increasing diameter of the arc of circumference formed by the flexible member with respect to a diameter of the logs to be cut;
inserting a new log to be cut into the arc of circumference defined by the flexible member;
reducing the diameter of the arc of circumference defined by the flexible member.

45. The method of claim 44, wherein the releasing of the flexible member by increasing the diameter of the arc of circumference formed by the flexible member further comprises moving an anchoring point of a control mechanism to the flexible member away from the supporting and sliding surface of the logs; and wherein the reducing of the diameter of the arc of circumference defined by the flexible member comprises moving the anchoring point of the control mechanism to the flexible member toward the supporting and sliding surface.
